(19) United States
(12) Patent Application Publication
(10) Pub. No.: US 2007/0121316 A1
(43) Pub. Date: May 31, 2007

(54) Garage door drive with a light unit

(76) Inventor: Michael Hoermann, Oerlinghausen (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/289,767

(22) Filed: Nov. 28, 2005

(51) Int. Cl. F21S 8/00

(52) U.S. Cl. 362/145

(57) ABSTRACT

The invention relates to a garage door drive comprising a housing and at least one light unit. In accordance with the invention at least one mounting position for mechanical and electrical connection to a light unit is insertable into at least one receiver at the housing.

The invention relates to a garage door drive comprising a housing and at least one light unit.

It is already known to combine garage door drives with a light unit to illuminate the garage. In this case, the known light units are as a rule integrated into the housing of the garage door drive. For this purpose, a part of the housing must have corresponding mounts for the lamps and a part of the housing must be designed as a transparent cover. The overall size of the garage door drive thereby becomes large. Due to the integrated light unit in the housing, the entire drive is also more expensive. Finally, it is comparatively complex to change defective lamps since the transparent cover has to be removed from the housing and the lamp has to be unscrewed from the mount in order to replace it with a new lamp.

A garage door drive with a light unit is already known from DE 203 05 579 U in which a plurality of mounting positions are fixedly integrated at the housing for the mechanical and electrical connection of the light unit made in a mountable and removable manner. A respective plug-ready cabling is provided in the housing here and the light unit can then be plugged into said cabling. A plurality of mounting positions, onto which corresponding light units can be mounted only as required, are in particular provided with garage door drive housings of a modular design which should be usable for different types of garage door drives. This means that, for example when six mounting positions are provided and two light units are plugged in, four mounting positions are unused. These mounting positions are, however, all pre-cabled and provided with electrical connection terminals.

It is the object of the present invention to further develop a generic garage door drive with a light unit such that the effort for the pre-fitting of the housing is minimized as much as possible even when a plurality of mounting positions are provided at the housing.

This object is solved in accordance with the invention in that, with a generic garage door drive, at least one mounting positions can be used in at least one receiver at the housing for the mechanical and electrical connection to a light unit. In accordance with the solution of the invention, only mechanical receivers have to be provided at the housing which can be taken into account on the shaping of the housing. This receiver only serves the mechanical reception, but not the electrical connection. The corresponding cabling and the corresponding installation and provision of electrical contacts are thus omitted in the receiver positions. The electrical contacting takes place in accordance with the invention by separately mountable mounting positions which serve the mechanical and electrical connection to respective light units. They are plugged into the corresponding housing receiver mechanically and are latched there. These mounting positions, which only have to be mounted to the receivers in the housing in the number which will then later actually carry light units, are connected to the power source with electrical cabling. The assembly effort for the housing of the garage door drive can hereby be further simplified.

Advantageous aspects of the invention result from the dependent claims following on from the main claim. The light unit can thus consist of a lamp fitting for a lamp which can be mounted onto and latched to a mounting position.

Further features, details and advantages of the invention result from the embodiment shown in the drawing. There are shown:

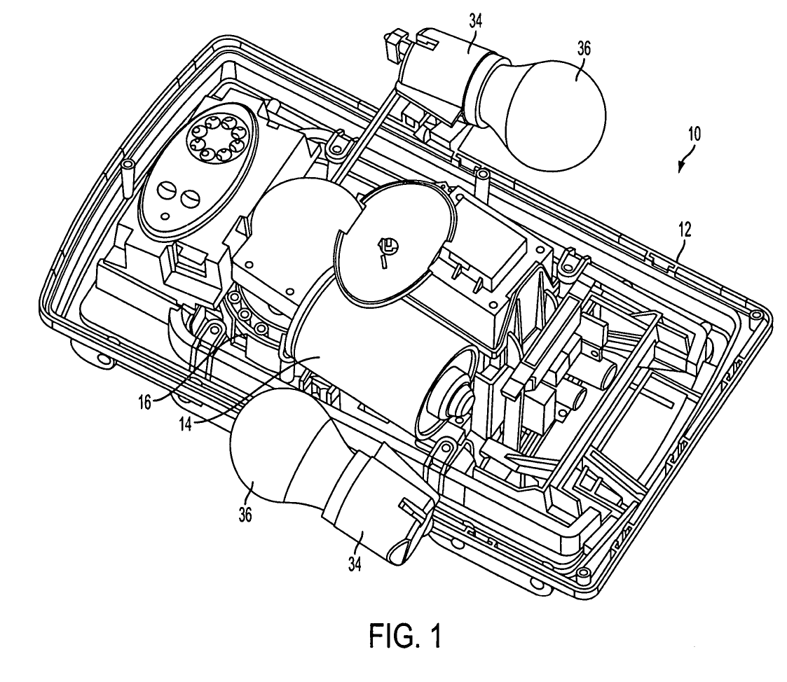

FIG. 1: a garage door drive with mounted light units, open, in a view from above;

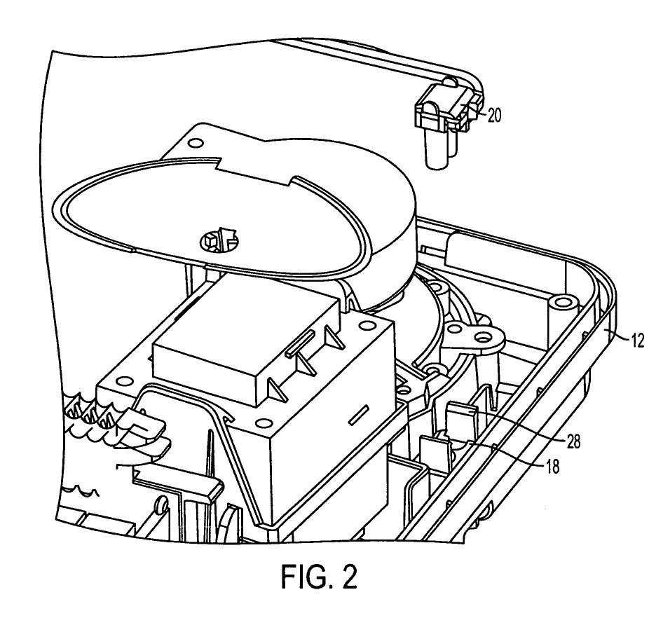

FIG. 2: a detail of the garage door drive in accordance with FIG. 1;

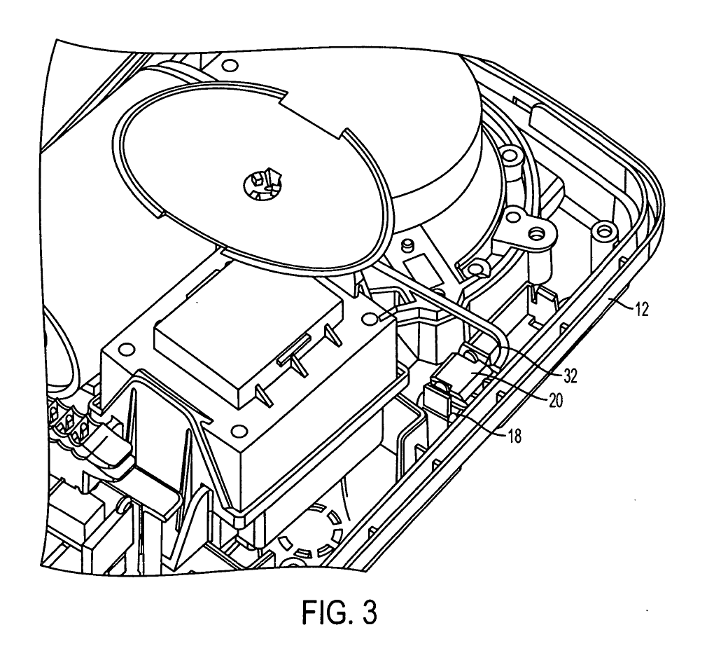

FIG. 3: a detail of the garage door drive in accordance with FIG. 1 with a plugged-in mounting position; and

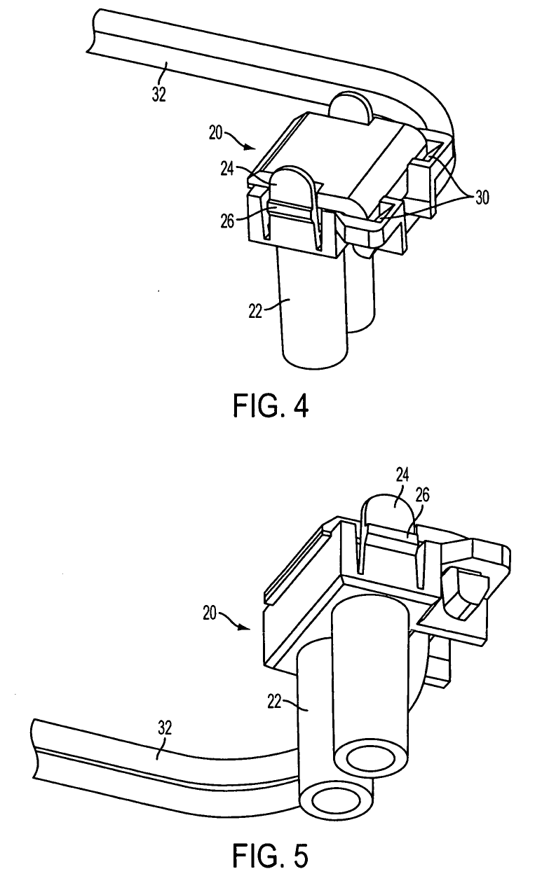

FIG. 4: different perspective representations of a mounting position for use in the garage door drive in accordance with the invention.

A garage door drive 10 is shown in FIG. 1 which accommodates a motor 14 inside the housing 12, of which only the lower side is shown, and drives a corresponding pulling [symbol] ns 16 via said motor, said pulling means running in a correspondingly C-shaped rail (14) in a sufficiently known manner. Since garage door drives of this type of construction are largely known, a detailed description is superfluous at this point. Reference is made to DE 203 03 315 U with respect to the structure of such a door drive housing for such a garage door drive. In particular the modular structure of a corresponding housing for a garage door drive is shown in detail there.

As can, for example, be seen from FIG. 2, a row of receivers 18 is provided in the region of the housing 12 and pluggable mounting positions 20 can be mounted on said receivers. The receivers 18 are provided at predetermined positions of the housing 12. In the representation in accordance with FIG. 2, only one receiver can be seen. In the embodiment shown here, however, four receivers 18 can, for example, be provided, with them being arranged symmetrically at the edge of the housing. In a modular extension of the housing, as many more receivers as desired can also be provided. Depending on requirements, mounting positions 20 are now plugged into the receivers to be able to mount light units to be supplied with power onto these mounting positions. In FIG. 3, a mounting position 20 is inserted by way of example into a corresponding receiver 18 of the housing.

The precise structure of the mounting position 20 results from FIGS. 4 and 5. The mounting position 20 is made as an injection-molded part and has, on the one hand, two cylindrical projections 22 which can be plugged into corresponding cut-outs in the receiver 18 on the housing side to permit a mechanical securing in the housing 12 here. Movable tongues 24 are provided at the side at the mounting position 20 and have latch projections 26 for latching with corresponding projecting noses 28 in the region of the receivers on the housing side (cf. FIG. 2). The mounting positions furthermore have electrical contacts 30, with these electrical contacts 30 being supplied with power via a power supply cable 32. The power supply cable 32 is then connected in each case to a power supply in the housing 12 (in a manner not shown in any more detail). Respective lamp fittings 34 can be mounted onto the mounting position 20 and are made, for example, as lamp fittings for lamps 26.

1. A garage door drive comprising a housing and at least one light unit,
wherein
at least one mounting position for mechanical and electrical connection to a light unit is insertable into at least one receiver at the housing.

2. The garage door drive according to claim 1, wherein the at least one mounting position is detachably mechanically connectable to the at least one receiver at the housing.

3. The garage door drive according to claim 2, wherein the mechanical connection is a latch connection.

4. The garage door drive according to claim 3, wherein the at least one mounting position carries electrical contacts for the power supply of the light unit mountable thereon.

5. The garage door drive according to claim 4, wherein the electrical contacts of the at least one mounting position are supplied with power via a power supply cable.

6. The garage door drive according to claim 1, wherein the light unit includes a lamp fitting for a lamp mountable and latchable to a mounting position.

7. A garage door drive comprising:
a housing having at least one receiver;
at least one light unit; and
at least one mounting portion configured for mechanical and electrical connection to said light unit, said at least one mounting portion further configured to be insertable into said at least one receiver at the housing.

8. The garage door drive according to claim 7, wherein the at least one mounting portion is configured to be detachably mechanically connectable to the at least one receiver at the housing.

9. The garage door drive according to claim 8, wherein the mechanical connection is a latch connection.

10. The garage door drive according to claim 9, wherein the at least one mounting portion carries electrical contacts configured to provide a supply of power to the light unit mountable thereon.

11. The garage door drive according to claim 10, wherein the electrical contacts of the at least one mounting portion are configured to be supplied with power via a power supply cable.

12. The garage door drive according to claim 11, wherein the light unit further includes a lamp fitting configured to enable a lamp to be mountable and latchable to a mounting position.
